(19) United States
(12) Patent Application Publication
(10) Pub. No.: US 2024/0265261 A1
(43) Pub. Date: Aug. 8, 2024

(54) ACOUSTIC MACHINE LEARNING WITH TRANSPARENT AND INTERPRETABLE ADAPTATION OF ACOUSTIC DATA BETWEEN ENVIRONMENTS

(71) Applicant: INTERNATIONAL BUSINESS MACHINES CORPORATION, Armonk, NY (US)

(72) Inventors: Jae-Wook Ahn, Montvale, NJ (US); Nirmit V Desai, Yorktown Heights, NY (US); Chunheng Jiang, Santa Clara, CA (US)

(21) Appl. No.: 18/105,077

(22) Filed: Feb. 2, 2023

(51) Int. Cl. G06N 3/084; G06F 3/0481; G06F 3/04847; G06N 3/0464

(52) U.S. Cl. CPC G06N 3/084; G06F 3/0481; G06F 3/04847; G06N 3/0464

(57) ABSTRACT

In various examples, a computer-implemented method includes: receiving, by one or more processing devices, acoustic content data; receiving, by the one or more processing devices, acoustic data for a target environment; training, by the one or more processing devices, a neural network model on the acoustic data for the target environment to extract features of the target environment; using, by the one or more processing devices, the neural network model to transfer the features of the target environment to the acoustic content data; constructing, by the one or more processing devices, the acoustic content data with the transferred features of the target environment; and outputting, by the one or more processing devices, via a user interface (UI), information on and configurable options for the training of the neural network model on the acoustic data for the target environment.

### BACKGROUND

Aspects of the present invention relate generally to machine learning, and, more particularly, to training acoustic machine learning models with acoustic data.

Acoustic machine learning models trained on acoustic data have a wide variety of useful applications, such as automated detection of phenomena in city streets, automated detection of anomalies for quality assurance in manufacturing and industrial settings, automated detection of medical information and identifying health issues by audio observation of body sounds, and automated detection and tracking of wildlife, including to support observation and protection of endangered species. Acoustic machine learning models trained on acoustic data have their own particular characteristics, distinct from those of more thoroughly addressed fields such as machine vision and natural language machine learning models.

### SUMMARY

In a first aspect of the invention, there is a computer-implemented method including: receiving, by one or more processing devices, acoustic content data; receiving, by the one or more processing devices, acoustic data for a target environment; training, by the one or more processing devices, a neural network model on the acoustic data for the target environment to extract features of the target environment; using, by the one or more processing devices, the neural network model to transfer the features of the target environment to the acoustic content data; constructing, by the one or more processing devices, the acoustic content data with the transferred features of the target environment; and outputting, by the one or more processing devices, via a user interface (UI), information on and configurable options for the training of the neural network model on the acoustic data for the target environment.

In another aspect of the invention, there is a computer program product including one or more computer readable storage media having program instructions collectively stored on the one or more computer readable storage media. The program instructions are executable to: receive acoustic content data; receive acoustic data for a target environment; train a neural network model on the acoustic data for the target environment to extract features of the target environment; use the neural network model to transfer the features of the target environment to the acoustic content data; construct the acoustic content data with the transferred features of the target environment; and output, via a user interface (UI), information on and configurable options for the training of the neural network model on the acoustic data for the target environment.

In another aspect of the invention, there is a system including a processor set, one or more computer readable storage media, and program instructions collectively stored on the one or more computer readable storage media. The program instructions are executable to: receive acoustic content data; receive acoustic data for a target environment; train a neural network model on the acoustic data for the target environment to extract features of the target environment; use the neural network model to transfer the features of the target environment to the acoustic content data; construct the acoustic content data with the transferred features of the target environment; and output, via a user interface (UI), information on and configurable options for the training of the neural network model on the acoustic data for the target environment.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 shows a flowchart of an exemplary method in accordance with aspects of the invention.

FIG. 4 depicts a conceptual schematic of audio inputs being processed through neural network layers, in accordance with aspects of the invention.

FIG. 5 depicts a conceptual flow diagram for an audio environment transfer framework that acoustic model transfer code may implement, in accordance with aspects of the invention.

FIG. 6 shows spectrograms of an illustrative comparison between style transfer and audio mixing, in accordance with aspects of the invention.

FIG. 7 shows graphs of results from experimentation with an example neural acoustic environment style transfer method of this disclosure, performed with an example implementation of acoustic model transfer code, in accordance with aspects of the invention.

### DETAILED DESCRIPTION

Aspects of the present invention relate generally to machine learning with acoustic data, and more particularly, to transparent and interpretable adaptation of acoustic data between environments for acoustic applications of machine learning. Since acoustic phenomena of interest typically occur in various environments in the real world and not in anechoic chambers, acoustic data from discrete phenomena are almost always admixed with environmental acoustic data. Acoustic data to train acoustic machine learning models are sensitive to environmental changes. The same objects can create different acoustic signatures in different environments.

Targeted content audio data are often intermingled with ambient environmental data. It is a challenging problem to isolate how the same set of content audio data can be transferred from one environment and set of environmental audio data to another environment and set of environmental audio data. Conventional approaches may typically involve multiple microphones installed in different positions in acoustic painting tunnels, and measuring multiple ambient sounds depending on location and time. The same event (e.g., a crash, in a rapid crash detection and safety alert system) can generate different sounds combined with different ambient sounds in different environments. To try to collect acoustic data on a phenomenon of interest (e.g., a crash) to provide sufficiently useful machine learning acoustic training data covering applications involving the phenomenon (e.g., detecting sounds indicative of a crash in generalized, non-laboratory-controlled, real-world environments), conventional approaches may typically involve collecting acoustic data on the same kind of crash in a variety of acoustic environments.

However, it is challenging to try to record and collect acoustic data on a phenomenon in every general kind of acoustic environment in which it may occur in the real world. The limits on attempting to collect acoustic data on the same phenomenon in a generalized variety of environments of interest, in which the phenomenon is intended to be detected or observed, impose corresponding limitations on the capabilities of acoustic machine learning applications based on the data gathered in such a manner. In other words, an application powered by a machine learning model may likely only be capable of detecting the sound of a phenomenon in acoustic environments similar to those specific acoustic environments covered by the acoustic training data, and may likely be incapable of detecting the sound of the phenomenon in other real-world acoustic environments that don't happen to be similar to those covered by the acoustic training data.

Generalizing distinguishability of acoustic data of specific discrete phenomena of interest from environmental acoustic data, and enabling transfer of acoustic data of specific discrete phenomena of interest between environmental acoustic data sets from different environments, is thus a persistently difficult challenge in machine learning applications in acoustic data. In light of inventive insights of this disclosure, conventional approaches to solutions tend to be restricted to simplistic and brittle techniques in artificially narrow applications of limited general usefulness.

According to aspects of the invention, systems, methods, and devices may overcome these and other conventional limitations, and generate acoustic data adapted to the environmental changes, augment training data adapted to multiple acoustic environments, and provide generalized transfer of acoustic data between environments. In embodiments, systems, methods, and devices provide generalized transfer of acoustic data between environments with unprecedented kinds of transparent, interpretable, flexible, and explainable tools and techniques for users to iteratively explore and refine specifics of transfer of acoustic data between environments. In this manner, implementations of the present invention provide a framework to facilitate unlocking new capabilities and new insights for iteratively understanding and refining novel techniques for generalized transfer of acoustic data between environments, and thereby new capabilities for developing acoustic applications of machine learning.

Aspects of the present disclosure go beyond ad hoc audio data augmentation and beyond synthesizing sounds by manipulating sound data, such as noise injection, time shifting, pitch change, and speed change. Aspects of the present disclosure involve learning object sounds and environment sounds. Aspects of the present disclosure go beyond generic acoustic style transfer, beyond room simulation specific to certain, narrowly defined environments, and beyond limited numbers of ad hoc features such as distance between sound source and microphones only. Rather, aspects of the present disclosure may successfully address generalized, real-world environments, and address environment acoustic signatures having generalized variations. Aspects of the present disclosure further output rich sets of information on the internals of the neural acoustic environment transfer machine learning architecture, processes, and configurable hyperparameters, and provide a rich set of transparent and explainable tools and techniques for users to understand and iteratively modify and improve on generalizable environment acoustic signatures and transfers.

Various aspects of this disclosure are directed to systems, methods, and computer program products for adapting acoustic data between distributed environments. The computer program product may include a computer readable storage medium having program instructions embodied therewith. The program instructions may be executable by one or more processing devices to cause the one or more processing devices to: receive acoustic content data for an object or other phenomenon of interest in a source environment; receive acoustic data for a target environment; train a convolutional or other neural network model using a plurality of convolutions, layers, or features to create representations of temporal features and environment features of the target environment; define a loss function representing the distance between the target environment and the object in the source environment; train the neural network model to adapt the object in the source environment to the target environment by minimizing the loss function; and construct the object audio data for the target environment using an audio phase construction algorithm. The program instructions may further be executable by one or more processing devices to cause the one or more processing devices to output, via a user interface (UI), information on and configurable options for the training of the neural network model on the acoustic data for the target environment.

Implementations of this disclosure are necessarily rooted in computer technology. For example, steps of training neural network models are necessarily computer-based and cannot be performed in the human mind. Further aspects of the present disclosure are beyond the capability of mental effort not only in scale and consistency but also technically and categorically. Further, aspects of this disclosure provide technological improvements and technological solutions to persistent, complex problems and challenges in automated detection of audio contents in real-world environments of arbitrary characteristics. Training and using an acoustic data transfer machine learning model are, by definition, performed by a computer and cannot conceivably be performed in the human mind (or with pen and paper) due to the complexity and massive amounts of calculations involved. For example, a neural network may have millions or even billions of weights that represent connections among nodes in one or more layers of the model. Values of these weights are adjusted, e.g., via backpropagation and stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model, and is even impossible for a human mind to conceive of or reproduce in a way that is categorically further from human mental conception than any traditional, human-written algorithmic software, as has been emphasized by noted experts in the field of art.

It should be understood that, to the extent implementations of the invention collect, store, or employ personal information provided by, or obtained from, individuals, such information shall be gathered only with prior consent of the individuals and used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

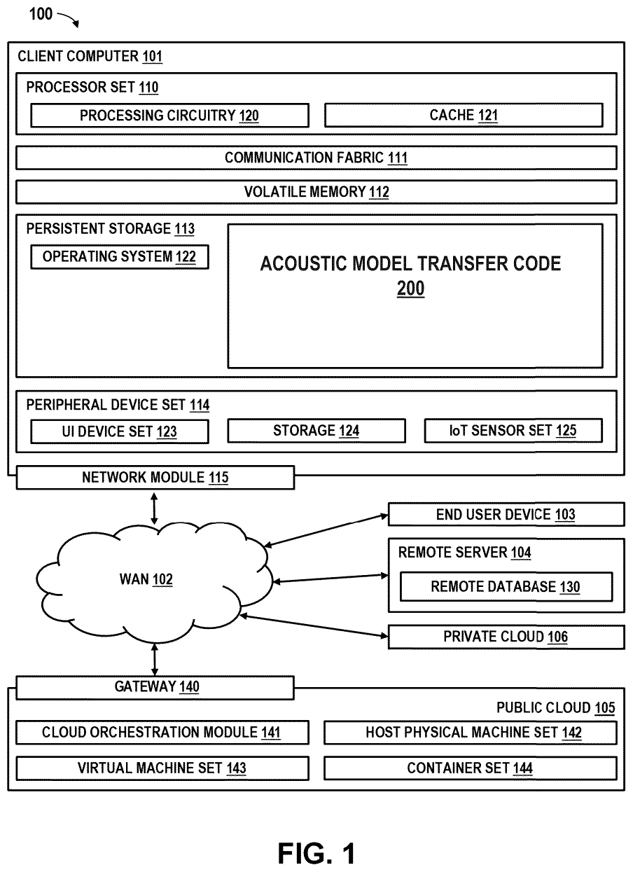

FIG. 1 depicts a computing environment 100 according to an embodiment of the present invention. Computing environment 100 contains an example of an environment for the execution of at least some of the computer code involved in performing the inventive methods, such as acoustic model transfer code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

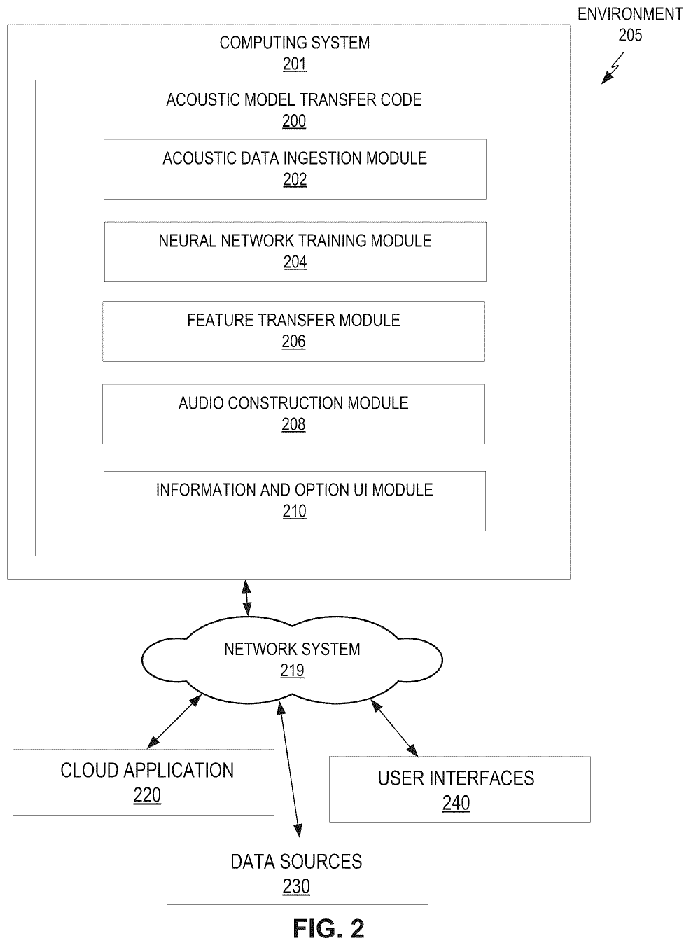

FIG. 2 shows a block diagram of an exemplary environment 205 in accordance with aspects of the invention. In embodiments, environment 205 includes computing system 201, which implements example acoustic model transfer code 200 of this disclosure, as introduced above. Computing system 201 may be implemented in a variety of configurations for implementing, storing, running, and/or embodying acoustic model transfer code 200. Computing system 201 may comprise one or more instances of computer 101 of FIG. 1, in various examples. Computing system 201 in various examples may comprise a cloud-deployed computing configuration, comprising processing devices, memory devices, and data storage devices dispersed across data centers of a regional or global cloud computing system, with various levels of networking connections, such that any or all of the data, code, and functions of acoustic model transfer code 200 may be distributed across this cloud computing environment. Acoustic model transfer code 200, computing system 201, and/or environment 205 may thus constitute and/or be considered an acoustic model transfer system, and may comprise and/or be constituted of one or more software systems, a combined hardware and software system, one or more hardware systems, components, or devices, one or more methods or processes, or other forms or embodiments.

In other examples, computing system 201 may comprise a single laptop computer, or a specialized machine learning workstation equipped with one or more graphics processing units (GPUs) and/or other specialized processing elements, or a collection of computers networked together in a local area network (LAN), or one or more server farms or data centers below the level of cloud deployment, or any of a wide variety of computing and processing system configurations, any of which may implement, store, run, and/or embody acoustic model transfer code 200. Acoustic model transfer code 200 may interact via network system 219 with any other proximate or network-connected computing systems, including cloud applications 220, data sources 230, and/or user interfaces 240, to perform any applicable methods, such as to perform machine learning training for acoustic environment transfer, and to surface user-perceptible and user-configurable network layers and architecture, hyperparameters, per-layer characteristics, training data, and any other information and options for machine learning training for acoustic environment transfer, in various aspects.

In embodiments, computing system 201 of FIG. 2, and any one or more computing devices or components thereof, comprises acoustic model transfer code 200. In various embodiments, acoustic model transfer code 200 comprises acoustic data ingestion module 202, neural network training module 204, feature transfer module 206, audio construction module 208, and information and option UI module 210, each of which may comprise modules of code of block 200 of FIG. 1. These modules of the code of block 200 are executable by the processing circuitry 120 of FIG. 1 to perform the inventive methods as described herein. Acoustic model transfer code 200 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

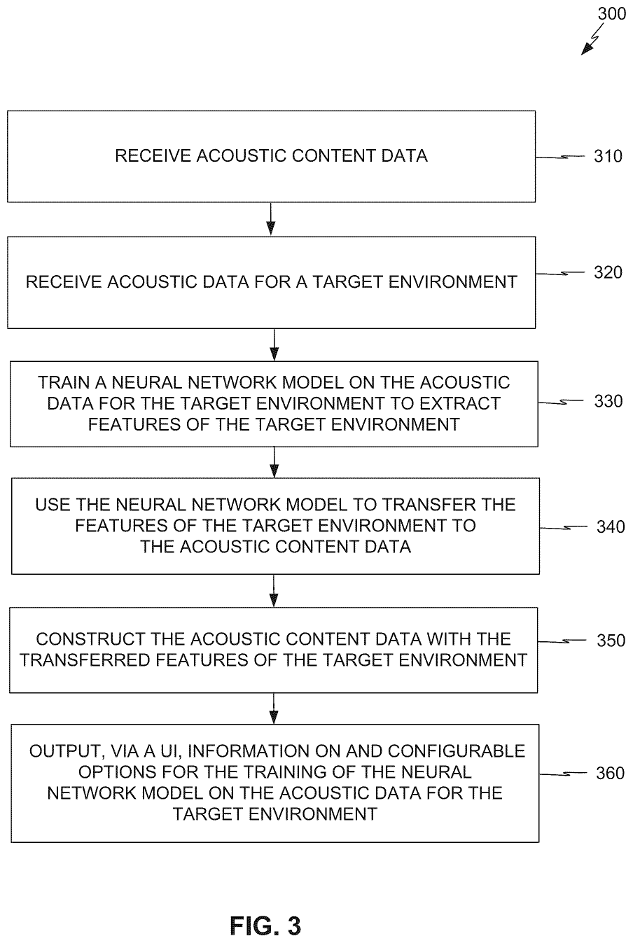

FIG. 3 shows a flowchart of an exemplary method 300 in accordance with aspects of the present invention. Steps of the method may be carried out in the environment of FIG. 2 and are described with reference to elements depicted in FIG. 2, including acoustic model transfer code 200.

At step 310, acoustic model transfer code 200 receives acoustic content data for a phenomenon of interest (e.g., via acoustic data ingestion module 202 of FIG. 2). In embodiments, at step 320, acoustic model transfer code 200 receives acoustic data for a target environment (e.g., via acoustic data ingestion module 202 of FIG. 2). At step 330, acoustic model transfer code 200 trains a neural network model on the acoustic data for the target environment to extract features of the target environment (e.g., via neural network training module 204 of FIG. 2). At step 340, acoustic model transfer code 200 uses the neural network model to transfer the features of the target environment to the acoustic content data (e.g., via feature transfer module 206 of FIG. 2). At step 350, acoustic model transfer code 200 constructs the acoustic content data with the transferred features of the target environment (e.g., via audio construction module 208 of FIG. 2). At step 360, acoustic model transfer code 200 outputs, via a user interface (UI), information on and configurable options for the training of the neural network model on the acoustic data for the target environment (e.g., via information and option UI module 210 of FIG. 2).

In various embodiments, systems, methods, and devices of this disclosure may learn environment features from one environment and transfer them to a content audio. For example, acoustic model transfer code 200 may learn environment features such as background ambient noise from one environment, and transfer them to a content audio, such as the sound of a crash, for example. Acoustic model transfer code 200 may get content features from source environments, and learn environment features from target environments. Acoustic model transfer code 200 may accurately represent specific environments, in various examples, in ways beyond the capabilities of conventional pretrained models or random noise for audio style transfer.

Acoustic model transfer code 200 may generate spectrograms for source content and a target environment, and train a convolutional neural network (CNN) or a CNN-based network. Acoustic model transfer code 200 may also train other kinds of neural networks or other kinds of machine learning networks and systems in other examples, such as recurrent neural networks, reinforcement learning systems, attention mechanism neural networks, or any other kinds of machine learning systems (which may collectively be referred to for purposes herein as “neural networks”). Acoustic model transfer code 200 may enable and use different convolution filter sizes, in contrast to conventional systems. Acoustic model transfer code 200 may enable wider convolution width to represent temporal features, such as echo and reverberation, for example. Acoustic model transfer code 200 may enable multiple convolutions per time to capture different frequency environmental features. Acoustic model transfer code 200 may obtain environment features from a lower layer of a learned network. Acoustic model transfer code 200 may use a gram matrix of activations of the neural nodes of a neural network.

Acoustic model transfer code 200 may define a loss function calculating the distance between a target environment and generated audio, and then train the model by iteratively minimizing the loss function. Acoustic model transfer code 200 may use an algorithm, such as the Griffin-Lim algorithm, for example, for the constructing of the audio data with the environment features transferred together with the source object content.

Acoustic model transfer code 200 may generate representative style signature on selected single or multiple lower-level layers with the corresponding convolutional feature maps, such that users can control which styles or environmental factors to transfer. Unlike traditional acoustic style transfer (using a single lower-level layer only) or image style transfer (using lower-level for styles and higher-level layer for contents), acoustic model transfer code 200 may take a more flexible approach, and transfer the acoustic environment, not just the acoustic style.

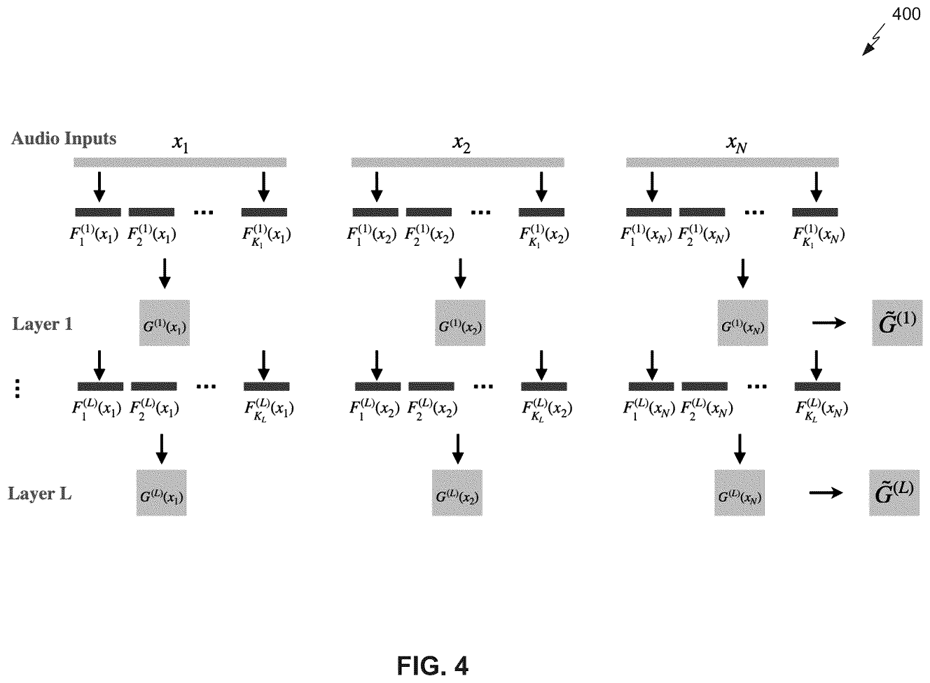

FIG. 4 shows a schematic 400 of a method in accordance with aspects of this disclosure, in which acoustic model transfer code 200 may extract or construct the style audio, in accordance with the loss minimization neural network training equations:

$${x}_{s} = arg {min}_{x} {L}_{s} ( x , {\tilde{G}}^{( 1 )} , … , {\tilde{G}}^{( L )} ) = {\sum }_{l = 1}^{L} {‖ {\tilde{G}}^{( l )} - {G}^{( l )} ( x ) ‖}_{F}^{2}$$

$${\tilde{G}}^{( l )} = {\sum }_{i = 1}^{N} {G}^{( i )} ( {x}_{i} ) / N or {\tilde{G}}^{( l )} = {\sum }_{i = 1}^{N} {G}_{k}^{( i )} ( {x}_{i} ) / N$$

where x and xₛ are the embedding features of the generated data and the target environment style audio, respectively, Gₖ⁽ⁱ⁾(xᵢ) is the low-rank approximation of G⁽ⁱ⁾(xᵢ) as Gram matrix style loss statistical indicators, and k controls the number of largest eigenvalues used for approximation. When N=1, acoustic model transfer code 200 may perform a denoising task, of separation of semantic content and implicit style. Given the same set of audio samples, acoustic model transfer code 200 may generate the same style audio with the representative acoustic environment extracted from the input audio clips.

Acoustic model transfer code 200 may output neural network training schematic 400 via one or more user interface elements, such as via display on a computer screen or a capacitive touchscreen, for example, as in step 360 in FIG. 3. FIG. 4 depicts a conceptual schematic of audio inputs being processed through neural network layers, in accordance with illustrative aspects of this disclosure. FIG. 4 shows an illustrative example of how acoustic model transfer code 200 may generate and output to a user interface a diverse variety of neural network architectures, layers to extract style information, style sources, and generators of style representations, including existing pre-trained convolutional neural network classifiers, in accordance with aspects of this disclosure. In other words, FIG. 4 shows an example of how acoustic model transfer code 200 may generate and output to a user interface a diverse variety of neural network architectures, layers to extract style information, style sources, and generators of style representations, including existing pre-trained convolutional neural network classifiers, in various examples. For example, acoustic model transfer code 200 may use and display a CNN in the class of the well-known CNN known as VGG, such as the VGG implementation known as VGGish. Beyond VGG and its related implementations, and in any other implementation of a neural network, acoustic model transfer code 200 may further output visual representations of intermediate neural training steps, thereby enabling transparency and interpretability of the acoustic environment transfer machine learning training, and enable users to see, manipulate, and modify each of the elements of example neural network training schematic 400. Acoustic model transfer code 200 may thus generate and output to a user interface a rich variety of options and techniques for users to understand and choose from, in iteratively generating and refining acoustic machine learning data transfer operations.

Acoustic model transfer code 200 may offer, via a user interface, options for which and how many lower-level layers are used to generate representative style features. Acoustic model transfer code 200 may enable user inputs or selections of either single or multiple audio clips sharing the same one or more environmental salient. Acoustic model transfer code 200 may enable user options for a wide variety of predefined generators, e.g., rank-reduced singular value decomposition (SVD) on the layer Gram matrices of a single audio clip, or an average on the set of per-layer Gram matrices of multiple audio clips. In manners such as these, acoustic model transfer code 200 may facilitate transparent understanding of all of the operating elements of the acoustic machine learning data transfer operations, rather than having the machine learning training processes operate in a conventionally obscure and unexplainable manner. In manners such as these, acoustic model transfer code 200 may enable users to have diverse and predictive understanding and control over the style transfer, and engage productively in targeted, driven development based on sound understanding and robust tools, rather than having to do trial-and-error testing.

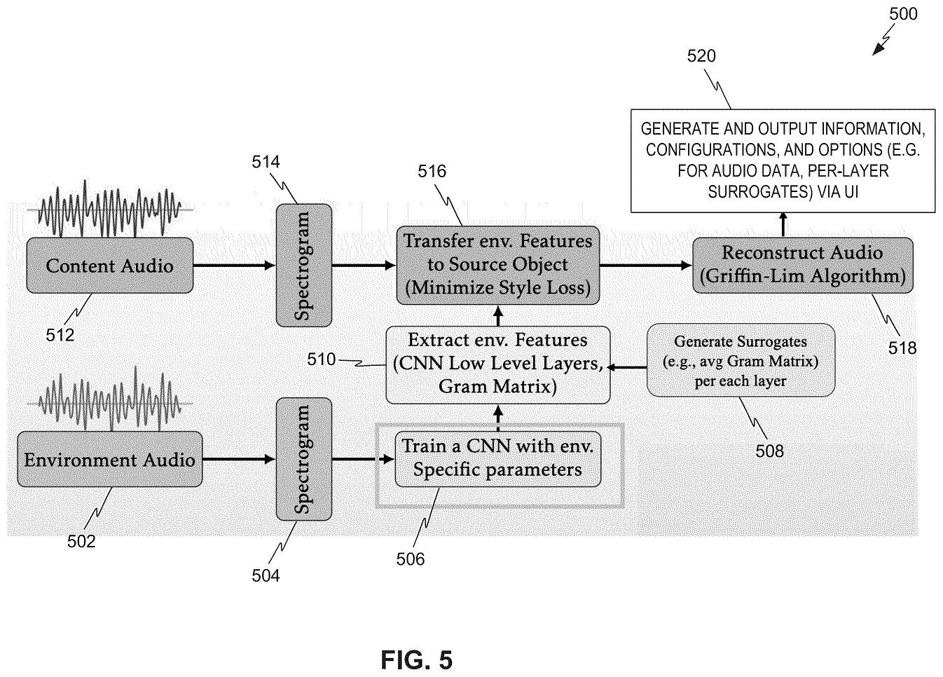

FIG. 5 depicts a conceptual flow diagram for an audio environment transfer framework 500 that acoustic model transfer code 200 may implement, in accordance with aspects of this disclosure. Acoustic model transfer code 200 processes the environment audio 502 and the content audio 512 to environment audio spectrogram 504 and content audio spectrogram 514, respectively. This may be part of or subsequent to the process of receiving or ingesting these data as in steps 310 and 320 of FIG. 3. Acoustic model transfer code 200 trains a CNN with environment-specific parameters of environment audio spectrogram 504, such as environment-specific training data and filter setup (506). This may be an example of step 330 or a part thereof of training a neural network model on acoustic data for the target environment, as in FIG. 3. Training the CNN with environment-specific parameters of environment audio spectrogram 504 may include using a novel convolutional filter configuration to enhance the method for environment audio. Acoustic model transfer code 200 generates surrogates per each layer, such as the average Gram matrix per each layer (508). Acoustic model transfer code 200 extracts the environmental features using the environment-specific trained CNN and using the generated surrogates per each layer, such as the CNN low level layers and the Gram matrix per layer (510). This may be another example of part of step 330, to extract features of the target environment, as in FIG. 3.

Acoustic model transfer code 200 transfers the environmental features to the source object of the content audio so that the resulting audio can represent the change of the content audio in a different environment, and with minimized style loss (516). This may be an example of step 340 of using the neural network model to transfer the features of the target environment to the acoustic content data, as in FIG. 3. Acoustic model transfer code 200 may then construct the content audio, such as by using the Griffin-Lim algorithm (518). This may be an example of step 350 of constructing the acoustic data with the transferred features of the target environment, as in FIG. 3. Acoustic model transfer code 200 may then generate, output, and surface for user interaction, a wide variety of configurations, architectures, information, and data from throughout the entire process, including the per-layer surrogates, the CNN architecture of the CNN used as a filter for the environment audio, the spectrograms, the environmental features, and so forth, via one or more user interface elements (520), thereby enabling users to examine aspects such as the audio data and the per-layer surrogates, and to select for the best results. This may be an example of outputting via a UI information on and configurable options for the training of the neural network on the acoustic data for the target environment, as in step 360 of FIG. 3.

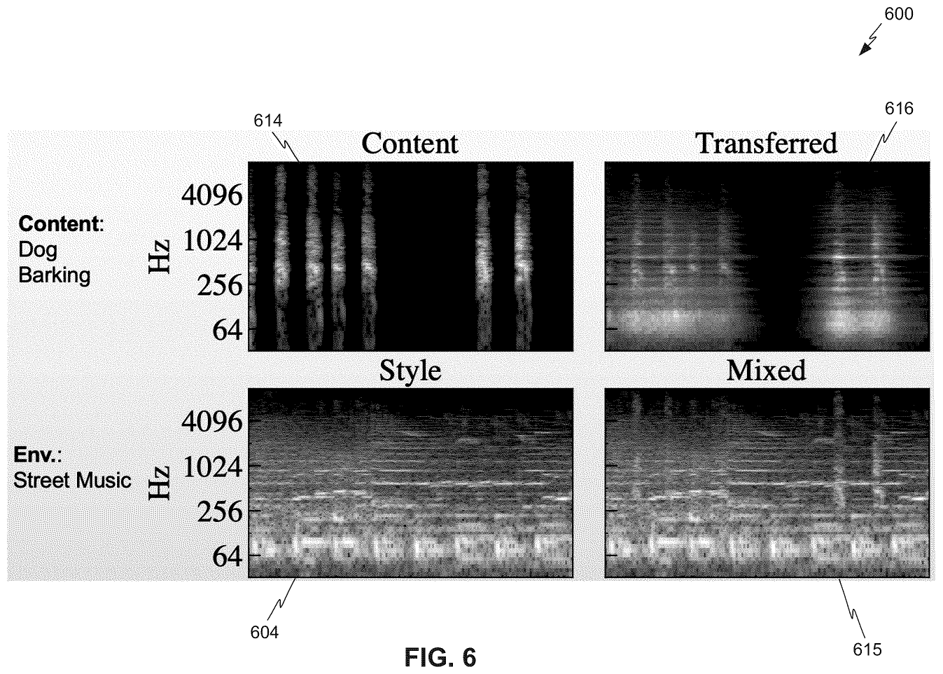

FIG. 6 shows spectrograms of an illustrative comparison between style transfer and audio mixing, in accordance with aspects of this disclosure. Specifically, FIG. 6 shows an environment audio spectrogram 604 of an environment audio file (e.g., of a street music acoustic environment); a content audio spectrogram 614 of a content audio file (e.g., of a dog barking); a mixed audio spectrogram 615 composed of a conventional simple mixture of environment audio spectrogram 604 and content audio spectrogram 614; and a CNN-filtered transfer spectrogram 616, generated by acoustic model transfer code 200 by a CNN-filtered transfer of environment acoustic features from environment audio spectrogram 604 to content audio spectrogram 614, in accordance with an illustrative method of this disclosure.

Environment audio spectrogram 604 and content audio spectrogram 614 are illustrative examples of environment audio spectrogram 504 and content audio spectrogram 514 as in FIG. 5. Acoustic model transfer code 200 may generate CNN-filtered transfer spectrogram 616 as an illustrative output of step 516 of FIG. 5, of transferring environmental features to a content audio spectrogram source object while minimizing style loss. As part of the process leading to generating CNN-filtered transfer spectrogram 616, acoustic model transfer code 200 may generate surrogates, e.g., average Gram matrix per each layer, as in step 508 of FIG. 5; train a CNN with environment specific parameters, such as using environment-specific training data and filter setup, as in step 506 of FIG. 5; and extract environmental features, e.g., CNN low level layers, and average Gram matrix per each CNN layer, as in step 510 of FIG. 5. Acoustic model transfer code 200 may use the resulting generated CNN-filtered transfer spectrogram 616 to construct audio, e.g., using the Griffin-Lim algorithm, as in step 518 of FIG. 5. Acoustic model transfer code 200 may further output audio and per-layer surrogates via a user interface in user-perceptible forms that are easily understandable and explainable, and enable receiving user inputs to select the best results and to iteratively develop CNN architectures and other configurations involved in the applicable processes, corresponding to step 520 of FIG. 5.

Acoustic model transfer code 200 may thus augment acoustic data between environments using adapted neural style transfer. Acoustic model transfer code 200 may generate environment features beyond simple styling. Acoustic model transfer code 200 may enable and support transparency and interpretability, so that users can understand, control, and iteratively explore the results. Acoustic model transfer code 200 may thereby enable and support users iteratively discovering more and more effective specific methods of environmental acoustic data transfer and acoustic data machine learning model training, in various examples.

Acoustic model transfer code 200 may surface diverse options for network architectures, network layers, audio style sources, and generators of audio style representations. Acoustic model transfer code 200 may facilitate user evaluation of audio results and per-layer surrogates with transparency and interpretability to facilitate the user selecting the best results. Acoustic model transfer code 200 may also generate per-layer surrogates, such as the average Gram matrix per each layer.

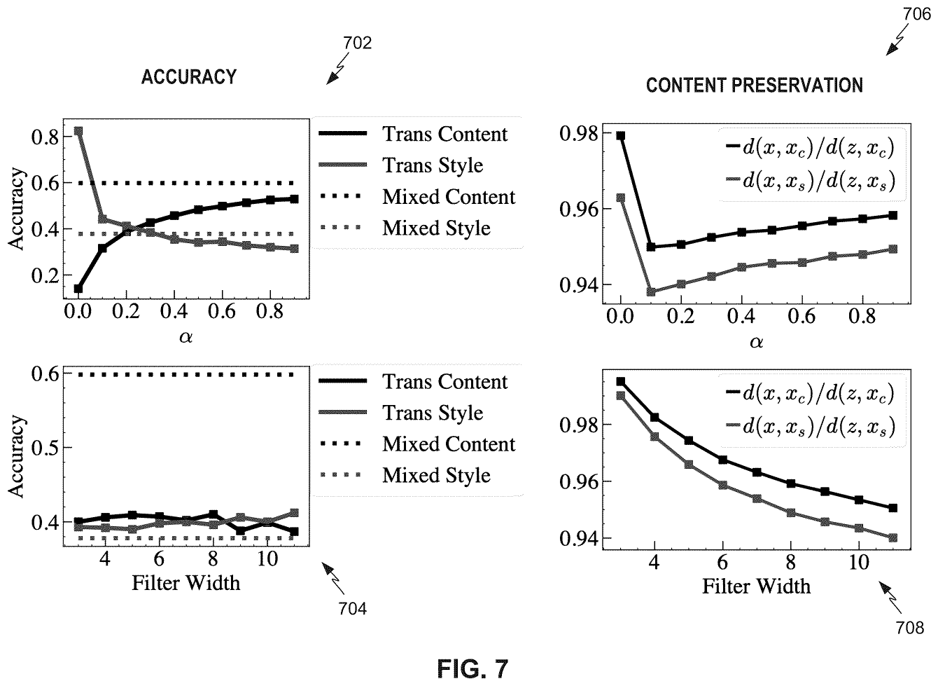

FIG. 7 shows graphs of results from experimentation with an example neural acoustic environment style transfer method of this disclosure, performed with an example implementation of acoustic model transfer code 200, in accordance with aspects of this disclosure. FIG. 7 shows graphs of results from experimentation with various options used for joint loss function scalar factor alpha (a, “alpha”) and filter width, as two configurable hyperparameters among several configurable hyperparameters of the CNN machine learning training process, which acoustic model transfer code 200 use to train the CNN for the neural acoustic environment style transfer method. There are many hyperparameters in the machine learning training framework, some or all of which may greatly affect the performance of the style transfer model. The scalar factor α in the joint loss objective function, and the filter size of the network architecture convolutional layer, were selected as representative parameters to study. These are among the parameters that are susceptible of being configured to optimize environment style transfer. Acoustic model transfer code 200 may surface these and other configurable hyperparameters of the CNN machine learning training process, illustratively as part of step 520 in FIG. 5.

As FIG. 7 shows, the example implementation of acoustic model transfer code 200 clearly shows improvements over simple data augmentation methods. FIG. 7 shows graphs 702, 704, 706, and 708 of accuracy (or strength of environmental transfer) and content preservation of the original content audio over a variety of options for both alpha and filter width, respectively, with alpha varied from 0 to 0.9, and filter width varied from 2 to 12. That is, graph 702 shows accuracy relative to alpha; graph 704 shows accuracy relative to filter width; graph 706 shows content preservation relative to alpha; and graph 708 shows content preservation relative to filter width. Graphs 702 and 704 show accuracy of transferred content and transferred style from the neural acoustic environment style transfer performed by acoustic model transfer code 200, as in CNN-filtered transfer spectrogram 616 of FIG. 6, in comparison with accuracy of mixed content and mixed style from a conventional mixture, as in conventional mixture spectrogram 615 of FIG. 6. Graphs 706 and 708 show content preservation of transferred content and transferred style from the neural acoustic environment style transfer performed by acoustic model transfer code 200, as in CNN-filtered transfer spectrogram 616 of FIG. 6, respectively.

The experimentation was performed using 1,000 pairs of sound clips the UrbanSound8K dataset, with samples labeled as foreground or background, to train a classifier, and to measure both the accuracy and content preservation. As FIG. 7 shows, a neural acoustic environment style transfer beats the classifier and the baseline audio synthesis or mixture. As shown in graph 702, as the scalar factor alpha (a) increases from 0 to 0.9, the effect of the transferred style and the generated data for the transferred style, relative to the content and its structure information, increases, with a corresponding effect on the recognizing ability of the trained classifier with respect to the content. The target style has an increasing trend in the generated data. An alpha factor of α=0.2 was found to render an intersection of prediction accuracy on content and style, and to be overall the best for environmental transfer, with the selection of other hyperparameters held constant at the levels used for the experimentation. As shown in graph 704, filter width had little apparent effect above noise on accuracy, with both content and style of the neural acoustic environment style transfer higher than style from the conventional mixture. In content preservation, as shown in graphs 706 and 708, after training the CNN, embedding distances were measured between generated data (x) and original data (x_{c}, xₛ), where the embedding distance d(x, x_{c}) is between the generated data and the content audio, and the embedding distance d(x, xₛ) is between the generated data to the target style audio, where x, x_{c}, and xₛ are the embedding features of the generated data, the content audio and the style audio, respectively. The denominators in the equations shown in the legend are normalization terms. Content preservation is shown to be higher than the baseline conventional audio mixture, with the derivative of neural environment transfer with respect to mixture being less than one, i.e., d(transfer)/d(mixture)<1.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor set, acoustic content data;
receiving, by the processor set, acoustic data for a target environment;
training, by the processor set, a neural network model on the acoustic data for the target environment to extract features of the target environment;
using, by the processor set, the neural network model to transfer the features of the target environment to the acoustic content data;
constructing, by the processor set, the acoustic content data with the transferred features of the target environment; and
outputting, by the processor set, via a user interface (UI), information on and configurable options for the training of the neural network model on the acoustic data for the target environment.

2. The method of claim 1, further comprising outputting, via the UI, information on and configurable options for the using of the neural network model to transfer the features of the target environment to the acoustic content data.

3. The method of claim 1, further comprising outputting, via the UI, information on and configurable options for the constructing of the acoustic content data with the transferred features of the target environment.

4. The method of claim 1, further comprising receiving, via the UI, user inputs to configure the configurable options for the training of the neural network model on the acoustic data for the target environment.

5. The method of claim 1, wherein using the neural network model to transfer the features of the target environment to the acoustic content data comprises using a plurality of neural network layers, the method further comprising:
generating one or more per-layer surrogates corresponding to one or more of the neural network layers.

6. The method of claim 5, wherein generating the one or more per-layer surrogates comprises generating an average Gram matrix per layer for the one or more of the neural network layers.

7. The method of claim 6, wherein outputting the information on and configurable options for the training of the neural network model on the acoustic data for the target environment comprises outputting the one or more per-layer surrogates.

8. The method of claim 1, wherein training the neural network model on the acoustic data for the target environment comprises training a convolutional neural network (CNN) using training data and a filter specific to the target environment.

9. The method of claim 1, further comprising enabling user inputs to select options from the information on and configurable options for the training of the neural network model on the acoustic data for the target environment.

10. The method of claim 1, wherein constructing the acoustic content data with the transferred features of the target environment comprises constructing the acoustic content data in accordance with:
$${x}_{s} = arg {min}_{x} {L}_{s} ( x , {\tilde{G}}^{( 1 )} , … , {\tilde{G}}^{( L )} ) = {\sum }_{l = 1}^{L} {‖ {\tilde{G}}^{( l )} - {G}^{( l )} ( x ) ‖}_{F}^{2}$$
$${\tilde{G}}^{( l )} = {\sum }_{i = 1}^{N} {G}^{( i )} ( {x}_{i} ) / N or {\tilde{G}}^{( l )} = {\sum }_{i = 1}^{N} {G}_{k}^{( i )} ( {x}_{i} ) / N$$
where x and xₛ are embedding features of generated data and the target environment, respectively, Gₖ⁽ⁱ⁾(xᵢ) is a low-rank approximation of G⁽ⁱ⁾(xᵢ), and k controls the number of largest eigenvalues used for approximation.

11. The method of claim 10, further comprising setting N=1; and
performing a denoising task to separate semantic content and implicit style.

12. The method of claim 1, wherein outputting the information on and configurable options for the training of the neural network model on the acoustic data for the target environment comprises enabling user-configurable options for a plurality of predefined generators.

13. The method of claim 12, wherein enabling the user-configurable options for the plurality of predefined generators comprises enabling user-configurable options for rank-reduced singular value decomposition (SVD) on per-layer Gram matrices of a single audio clip, and for an average on the set of per-layer Gram matrices of multiple audio clips.

14. A computer program product comprising one or more computer readable storage media having program instructions collectively stored on the one or more computer readable storage media, the program instructions executable to:
receive acoustic content data;
receive acoustic data for a target environment;
train a neural network model on the acoustic data for the target environment to extract features of the target environment;
use the neural network model to transfer the features of the target environment to the acoustic content data;
construct the acoustic content data with the transferred features of the target environment; and
output, via a user interface (UI), information on and configurable options for the training of the neural network model on the acoustic data for the target environment.

15. The computer program product of claim 14, wherein the program instructions are further executable to:
output, via the UI, information on and configurable options for the using of the neural network model to transfer the features of the target environment to the acoustic content data;
output, via the UI, information on and configurable options for the constructing of the acoustic content data with the transferred features of the target environment; and
receive, via the UI, user inputs to configure the configurable options for the training of the neural network model on the acoustic data for the target environment.

16. The computer program product of claim 14, wherein the program instructions are further executable to:
use a plurality of neural network layers for the transferring the features of the target environment to the acoustic content data; and
generate one or more per-layer surrogates corresponding to one or more of the neural network layers,
wherein generating the one or more per-layer surrogates comprises generating an average Gram matrix per layer for one or more neural network layers, and
wherein outputting the information on and configurable options for the training of the neural network model on the acoustic data for the target environment comprises outputting the one or more per-layer surrogates.

17. The computer program product of claim 14, wherein the program instructions executable to output the information on and configurable options for the training of the neural network model on the acoustic data for the target environment comprise program instructions executable to enable user-configurable options for a plurality of predefined generators,
wherein enabling the user-configurable options for a plurality of predefined generators comprises enabling user-configurable options for rank-reduced singular value decomposition (SVD) on per-layer Gram matrices of a single audio clip, and for an average on the set of per-layer Gram matrices of multiple audio clips.

18. A system comprising:
a processor set, one or more computer readable storage media, and program instructions collectively stored on the one or more computer readable storage media, the program instructions executable to:
receive acoustic content data;
receive acoustic data for a target environment;
train a neural network model on the acoustic data for the target environment to extract features of the target environment;
use the neural network model to transfer the features of the target environment to the acoustic content data;
construct the acoustic content data with the transferred features of the target environment; and
output, via a user interface (UI), information on and configurable options for the training of the neural network model on the acoustic data for the target environment.

19. The system of claim 18, wherein the program instructions are further executable to:
output, via the UI, information on and configurable options for the using of the neural network model to transfer the features of the target environment to the acoustic content data;
output, via the UI, information on and configurable options for the constructing of the acoustic content data with the transferred features of the target environment; and
receive, via the UI, user inputs to configure the configurable options for the training of the neural network model on the acoustic data for the target environment.

20. The system of claim 18, wherein the program instructions are further executable to:
use a plurality of neural network layers for the transferring the features of the target environment to the acoustic content data; and
generate one or more per-layer surrogates corresponding to one or more of the neural network layers,
wherein generating the one or more per-layer surrogates comprises generating an average Gram matrix per layer for one or more neural network layers, and
wherein outputting the information on and configurable options for the training of the neural network model on the acoustic data for the target environment comprises outputting the one or more per-layer surrogates.
